(19) United States
(12) Patent Application Publication
(10) Pub. No.: US 2010/0065370 A1
(43) Pub. Date: Mar. 18, 2010

(54) FALL PROTECTION

(75) Inventor: Heiko Frauendorf, Mainz (DE)

Correspondence Address: PAUL AND PAUL, 2000 MARKET STREET, SUITE 2900, PHILADELPHIA, PA, 19103, US

(73) Assignee: Lufthansa Engineering and Operational Services GmbH, Frankfurt (DE)

(21) Appl. No.: 12/368,580

(22) Filed: Feb. 10, 2009

(30) Foreign Application Priority Data
Feb. 11, 2008 (DE) 10 2008 008 577.4

(51) Int. Cl. A62B 35/04; A62B 1/16; E06C 7/18

(52) U.S. Cl. 182/3

(57) ABSTRACT

The present invention concerns a device for securing persons on maintenance work on aircraft surfaces, having a cable (2) stretched over the wing surface (1). In order to produce such a device or to provide such a device that it is essentially easier and cheaper than current vacuum retaining devices, wherein however under no circumstances the aircraft structures which are loaded by the device are loaded beyond an admissible threshold, in accordance with the invention, the cable (2) is stretched between a defined first anchor point (3) on the fuselage (4) above the wing surface (1) and a second defined anchor point (5) on the upper side of the wing surface (1) close to the end of the wing surface, wherein a damping device (7) is provided between the first and second anchor points (3, 5), whereby tensile forces occurring in the cable cause a defined lengthening of the cable.

The present invention relates to a safety device for maintenance personnel on aircraft wing surfaces, having a cable stretched above the wing surface.

Aircraft wing surfaces have to be maintained regularly and in order to retain their aerodynamic properties, they have to be thoroughly cleaned at relatively short intervals. The wing surfaces of passenger aircraft are thus usually designed so that they have specific zones which can be stepped on by maintenance personnel while other regions should not be stepped on if possible in order to prevent damage to the wing surface or other structures beneath it.

Since modern passenger aircraft are usually relatively large, such wing surfaces are typically at a distance of 3 metres or more from the ground. Any cleaning work and other maintenance work on the wing surfaces must therefore be carried out in accordance with the pertinent safety precautions and only with sufficient protection of the personnel working on the wing surfaces by means of suitable fall protection.

The wing surfaces of modern passenger jets can sometimes be 30 m long or more; thus, the personnel safety device has to be able to function properly over this entire length.

Such a personnel safety device for use in maintenance of aircraft wing surfaces is already known, whereby a plurality, typically up to six vacuum retaining devices are used which are placed at approximately regular intervals on the top surface of the aircraft wing surface and which grip by their undersides to the top surface of the wing surface by producing a vacuum. Clearly, such vacuum retaining devices require a relatively large suction surface in order to produce the required grip which has to be sufficient to catch a person secured via a safety line who falls over the edge of the wing surface in order to grip the wing surface securely and also in order to avoid point loading of the wing surface structure. Thus, the individual vacuum retaining devices not only have a correspondingly large surface which, following positioning of the retaining device, is no longer accessible to maintenance work, but a large number of appropriate vacuum retaining devices must be arranged along the surface of the wing surface whereby a safety cable connects all of the vacuum retaining devices together and wherein safety lines for each individual person are secured and guided on the cable.

That the vacuum retaining devices occupy certain surfaces means not only that such vacuum retaining devices, when carrying out the maintenance work and in particular when carrying out cleaning work, have to be released during the procedure and then displaced in order to gain access to the surfaces which were covered by the vacuum retaining devices, but that such vacuum retaining devices are also relatively cumbersome and expensive and require a permanent energy supply.

Further, at least in the airbus family, anchor points are provided at the regions near the wing tips and on the fuselage above the wing to which a safety cable can be attached.

It has transpired that on stretching a cable between the anchor point on the fuselage of an aircraft and a further anchor point near the tip of the wing surface, in the event of a person attached thereto falling, the forces occurring therein are greater than a threshold load for which such anchor points are designed. Thus, it is not possible to use a cable stretched between such anchor points by itself as a device for securing persons during maintenance work.

Having regard to the prior art, the aim of the present invention is to provide a device or to arrange such a device in such a manner that it is substantially simpler and cheaper than the known vacuum retaining device, and also will under no circumstances load the aircraft structures concerned beyond the allowable threshold.

This aim is achieved by dint of the fact that the cable is stretched between a defined first anchor point on the fuselage above the wing surface and a second defined anchor point on the upper side of the wing surface in the vicinity of the tip of the wing surface, wherein a damping device is provided between said two anchor points whereby tensile forces arising in the cable result in a defined lengthening of the cable.

It has transpired that using such a damping device it is possible that forces arising in the cable which may be produced by a person secured on the cable via additional personal protection equipment (abbreviated to PPE) when that person falls over an edge of the wing surface, can be limited by the damping device in such a manner that the load threshold in the anchor points is not exceeded. To this end, the damping device must effectively allow the cable to lengthen which in practice can be directly limited in such a manner that the function of the cable as a fall protection device is not affected and nevertheless, the loading thresholds for the anchor points are not exceeded. The PPE comprises, inter alia, a safety line, which is also connected to the cable.

If necessary, with very long wing surfaces, an additional anchor point may be placed approximately in the centre between the anchor points (end points) of the safety line; such an anchor point may be a prior art vacuum retaining device.

Advantageously, the damping device is integrated into the cable, wherein a cable is selected with a specific load-extension ratio which is selected such that a person falling from the wing surface (or a falling weight of 100 kg, for example) on arresting produces a force in the cable which at its peak does not exceed a value of 4 kN, for example.

This procedure is normally dynamic, i.e. in the event of a person falling, the cable to which the falling person is secured via an additional safety line, is deflected laterally and a peak force occurs when after the person falls a specific distance the safety line tightens, whereby the cable is deflected in a direction perpendicular to its tensing direction between the anchor points and thus the tension in the cable is drastically increased. With increasing force, however, the cable extends to such an extent that the force thresholds mentioned above are not exceeded. Alternatively, a less extensible (hard) cable can be used in combination with a separate damping device which can loosen the cable by a limited amount as a function of the force thresholds so that it lengthens and thus the force peak which would otherwise arise in the cable and the anchor points can be damped. This also has the advantage that in addition, the force in the jerkily tensed safety line to which the secured person is hooked is damped. In accordance with the invention, the extension of the cable per kN is set at approximately 1%. On the other hand, however, certain maximum values for the extensibility should not be exceeded as if it were to be, the cable could give so much that a falling person could hit the ground. In accordance with one embodiment, then, the value of the extension does not exceed 4% per kN. Preferred values for the load-extension (in the linear region) are between 0.5 and 2% kN, in particular between 0.8 and 1.2%/kN.

If a separate damping device is used, it only releases an additional length of cable when an upper threshold for the tensile stress is reached, whereby this threshold is a maximum of 6 kN. In accordance with a further embodiment of the invention, this threshold is set at not less than 4 kN. Further, in accordance with an embodiment of the present invention, the damping device is designed such that it stops the additional cable release as soon as the tensile stress in the cable goes below a lower threshold. In accordance with a variation of the invention, this lower threshold is approximately 4 kN or somewhat more.

Further, in one embodiment of the invention, wherein in addition, a cable tensing device is provided between the anchor points which produces a tension in the cable (which may be adjustable). In accordance with one variation of the invention, the cable tensing device is designed so that the cable tension is adjusted to a value between 0.3 and 1 kN, for example to approximately 0.5 kN. This cable tensing device ensures that the cable is always pre-tensed and at no time hangs loosely. If it were loose, this would mean that a tailing person would have an additional distance to fall before the cable tensed and a force were to be exerted in the damping device, whereupon the tardily activated damping device would provide an additional length of cable and the distance remaining for the person to fall to the ground might well not be sufficient to produce sufficient kinetic energy in the damping device due to the additional drop distance to arrest the fall and prevent him hitting the ground. In particular, pre-tensing the cable is also particularly helpful when because of its force-extension behaviour the cable comprises an integrated damping device since the initial extension of an extensible cable is often over-proportionally high (for example over 4% per kN) and this additional extension is cancelled out by the pre-tensing device.

Clearly, it is also possible to integrate the damping device and the cable tensing device into a single device, i.e. cable tensing device and damping device are identical or combined into a single unit.

In the case in which the wing surface is extremely long, over 20 m, so that the cable length is approximately twenty metres or more between the anchor points, an additional vacuum anchor can be provided approximately in the central region between the anchor points for the stretched cable, which secures the stretched cable against excessive lateral deflections. Furthermore, with very long cable lengths there is a danger that despite a considerable lateral deflection in approximately the centre of the cable the tensile force in the cable would not yet be high enough for the damping device to be triggered or the cable extension under a moderate tensile force would allow too high a lateral deflection, which could result in a much longer fall for a falling person, who could thus be injured. Too long a free length for the safety cable could result in the damping device being triggered relatively late, which then in order to dampen the peak force would release so much extra cable or would allow too much extension of the cable, that it could no longer be guaranteed that the falling person would not hit the ground.

Clearly, an additional vacuum retaining device would bring with it the disadvantages mentioned above, namely that this part covers the surface to be maintained or cleaned, however in contrast to the prior art we have in this case just one vacuum retaining device so that the effort of displacing it just once is comparatively small and also the rather costs arising from using the vacuum retaining device are also drastically reduced since, for example, only one instead of 6 vacuum retaining devices are required and this would only be used for particularly large wing surfaces.

In accordance with one embodiment of the invention, a three-quarter inch thread is provided at the anchor points, whereby these anchor points are provided with a threaded bolt which fits therewith and has a cable ring into which either a cable loop can be placed or onto which a spring hook which is attached to one end of the cable can be hooked.

When fastened to load-hearing structural elements of the aircraft or the wing surface, such anchor points are sufficient to withstand the maximum tensile forces which may arise when using the damping device of the invention.

Furthermore, in accordance with an embodiment of the invention, at least one guide bush which grips around the cable is provided, wherein said guide bush is designed for connecting a safety line to the cable. Normally, such guide bushes are always arranged on the cable and these have, for example, an O-ring or the like into which a maintenance technician can fix the end of his personal safety line, for example using a spring hook, whereby the safety line is also connected with a safety harness into which the person's body is securely fastened.

Advantageously, at least two such guide bushes are provided so that several people can work simultaneously on the wing surface and thus are secured by the cable. If an appropriate vacuum retainer or vacuum anchor is, for example, additionally provided in the centre between the two anchor points, at least one guide bush should be provided either side of the vacuum anchor; preferably, at least two such guide bushes should be provided either side of the vacuum anchor. This is particularly advantageous when the guide bushes and the vacuum anchor are designed so that the guide bushes cannot be moved past or over the vacuum anchor.

Further, in accordance with an embodiment of the invention, at least one guide bush has a safety clamping device which, on sudden longitudinal displacement of the guide bush along the cable, clamps the guide bush onto the cable. Such clamping devices can, for example, be actuated by inertial sensors or lever mechanisms which not only react to a rapid and sudden movement of the guide bush but also to a very small angle between the cable and the safety line fastened to the cable via the guide bush.

Under the threaded bolt on the anchor points, in accordance with one embodiment of the invention, large underlay plates are provided the colour of which is substantially different from the colour of the wing surface and the fuselage in the region of the anchor points. Such large and contrasting colour underlay plates ensure that, after completing the maintenance work, the threaded bolts which are screwed into the anchor points fixed on the aircraft (which have matching shaped sheaths with internal threads in the wing surface or fuselage), can be removed; the large underlay plates make the presence of the threaded bolts visible even from a large distance, while the threaded bolts alone may be overlooked.

In accordance with one embodiment, the surface area of the underlay plates is at least 100 cm² and preferably at least 200 cm². The underlay plates can be circular in shape in top view or formed as a sector of a circle in top view, but may also be triangular, square or have any polygonal shape. Preferably, they are produced in the warning colours of red or orange, but underlay plates in other colours may be used if the colour of the wing surface or the fuselage does not provide a sufficient contrast to red or orange underlay plates.

Further advantages, details and applications of the present invention will become apparent from the following description of a preferred embodiment and the accompanying figures, which show:

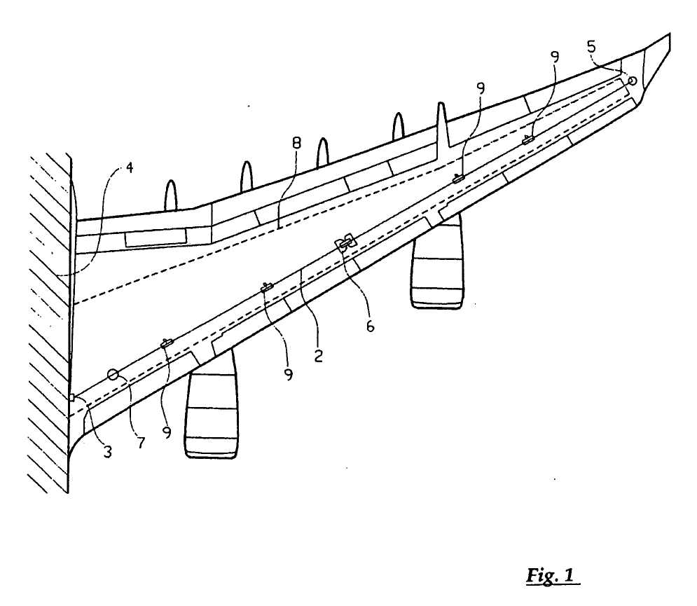

FIG. 1 shows a top view a relatively long wing surface of a four-engined wide bodied aircraft (Airbus A 340) with a cable slung between anchor points and an additional vacuum anchor:

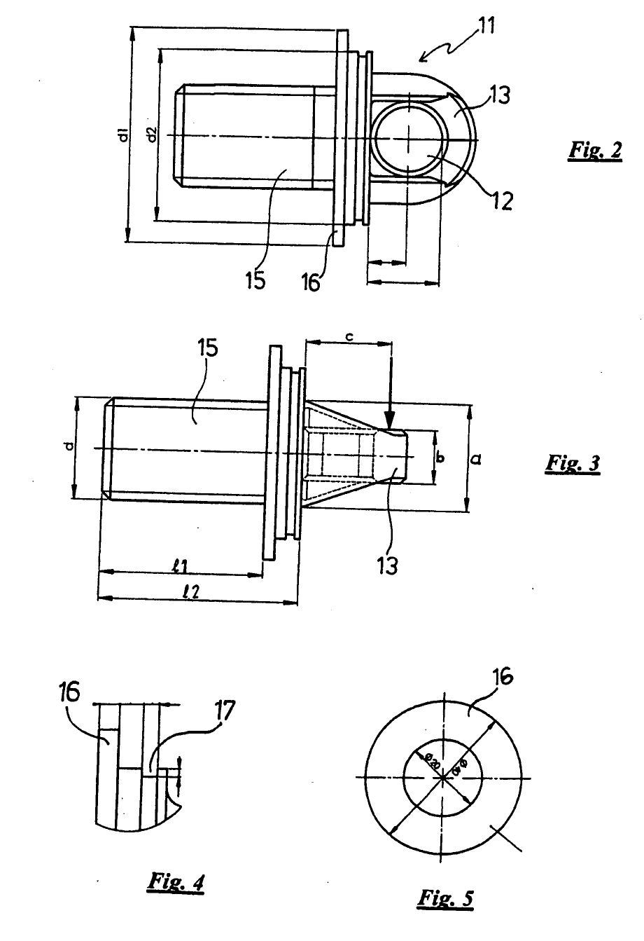

FIG. 2 shows a side view of a securing bolt for screwing into the sheath of an anchor point 1;

FIG. 3 shows a securing bolt viewed at 90° to that of FIG. 2;

FIG. 4 shows a detailed view of region B of FIG. 2;

FIG. 5 show an elastic underlay plate for pushing over the threaded section of the bolt;

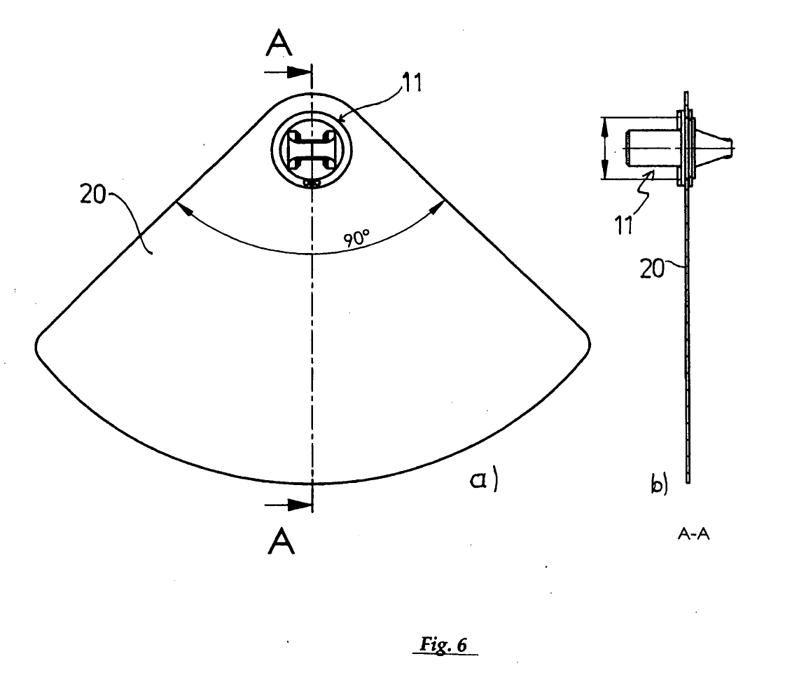

FIG. 6a shows a top view of a securing bolt with an underlay plate under it;

FIG. 6b sectional view of the bolt and the underlay plate of FIG. 6a taken along line AA;

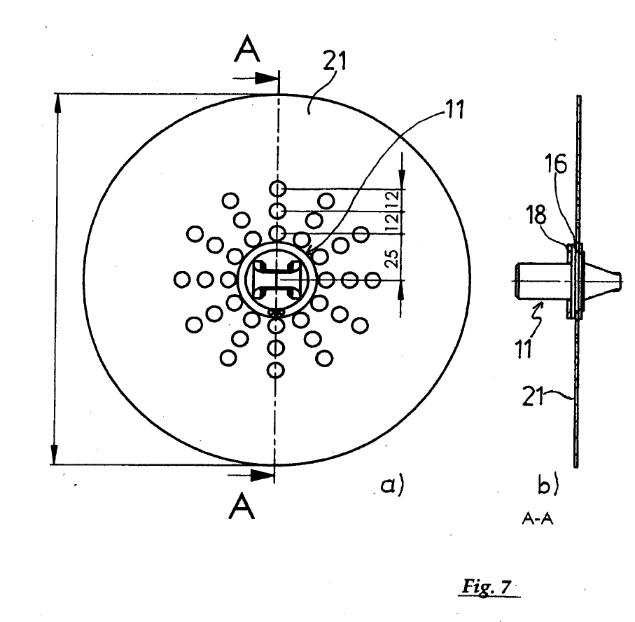

FIG. 7a shows a top view of a securing bolt with a circular underlay plate; and

FIG. 7b shows a section through the bolt and the underlay plate of FIG. 7a along line A-A in FIG. 7a.

The top view of FIG. 1 shows the wing surface of a wide body aircraft wherein the shape of the wing surface and other details in this case are those of the wing surface of the Airbus A 340-300. A field can be seen which extends a distance from the front and rear wing surface edges and reaches from the fuselage almost to the tip of the wing surface and is shown as a dotted line 8 which defines the region which can be stepped on during maintenance work, but beyond this dotted line are regions which should not be stepped on as far as possible. A safety cable 2 is fastened between a first anchor point 3 on the fuselage 4 of the aircraft and a further anchor point 5 close to the tip of the wing surface 1. In the vicinity of the anchor point 3 on the fuselage, a tensing device 7 of the invention is integrated into the cable 2, effectively producing a damping device which provides the cable with a specific force-extension behaviour and an extension between 0.5% and 1.5% per kN tensile stress. This cable tensing device can either be a mechanical tensing device which operates using a spring, an electromechanic tensing device which has an electromagnetic winding motor or a hydraulic or pneumatic device which also has an appropriate winding motor. The tensing device could in these cases simultaneously be used as a damping device, but other damping devices and tensing devices as well as combinations of different damping and tensing devices can also be envisaged, the principles of which are known in the art and the details of which do not form part of the subject matter of the present invention. In the embodiment shown, the damping is provided by the extensibility of cable 2 alone; the cable tensing device can be adjustable or can even simply ensure a fixed pre-tension so that the cable 2 is tensed and tightened between the two anchor end points or anchor points 3, 5. The maximum value of this pre-tensing should typically be in the region of 0.5 to 2 kN. The damping or extensibility of the cable is, however, selected so that any forces arising in the event of a fall are below the threshold at which the anchor point on the fuselage or the wing surface are dislodged. In many aircraft types, values below 6 kN tensile strength are considered to be safely below the maximum permissible threshold. The extensibility of the cable 2 is selected with this in mind. If necessary, the stresses occurring and the required damping properties of the cable or a separate damping device can be determined by means of simple drop tests using a weight, as these values depend on the total length of the safety cable, the free span of cable between one of the anchor points and the intermediate anchor as well as the maximum drop height to be allowed. In practice, a 0.5 kN pre-tensed safety cable with a load-extension of 1% per kN for an approximately 30 m long wing surface and a correspondingly long safety cable with an additional vacuum anchor approximately in the centre between the anchor points has proved to be suitable in securing a person against a fall of approximately 3.5 m without exceeding the threshold for loading at the anchor points.

In the example, between the anchor points 3, 5 is an additional vacuum anchor 6 approximately in the centre between the anchor points 3, 5 which, on producing a vacuum at its underside, grips the top surface of the wing surface; its top side carries guide rings for the passage of the taut cable. These guide rings can be arranged so that the cable in its non-tightened state can be hooked into the guide rings without having to use spring hooks or the like.

Further, either side of the vacuum anchor 6 are two guide bushes 9 which also have rings onto which the spring hook of a safety fine can be hooked. The maintenance or cleaning personnel each fix a safety line in the ring of a guide bush 9 and can then move parallel to the cable 2 in the longitudinal direction of the wing surface whereupon the guide bush slides with them along the cable. Since the guide bushes and the rings on the vacuum anchor are formed so that the guide bushes cannot be moved over the vacuum anchor, and remain in permanent contact with the rope 2, then on reaching the vacuum anchor the person has to release the safety line from the guide bush and connect to another guide bush on the other side of the vacuum anchor, in order to reach the other part of the wing surface. Because the vacuum anchor is used, it may also be the case that the run of the cable between anchor points 3 and 5 is not a straight line, but in the region of the vacuum anchor is slightly kinked; this does not affect the overall function of the invention.

Details of the anchor points or corresponding fixing bolts are shown in FIGS. 2-7.

FIG. 2 shows a side view of a threaded bolt 11 with a threaded section 15 which has a nominal diameter of three quarters of an inch. This threaded bolt has integrated washers 16 and a cable ring 12 at its head end. The cable ring 12 is formed by an approximately U-shaped armature 13 with an almost rectangular cross section which is integrally fixed to the head plate of the threaded holt and defines a circular opening with a sufficiently large radius to be able to pass therethrough a safety cable 2, a cable ring or another holding element at the end of the cable. In the present case the internal diameter of the cable ring is approximately 12 mm.

FIG. 3 shows the same safety bolt 11 but turned through an angle of 90° so that in this position the U-shaped armature 13 (partially covered and in dotted lines) forming the ring is shown with a simple rectangular contour. Between the threaded section 15 of the bolt 11 and the armature 13 at the head of the bolt can be seen the integrated washer 16 mentioned above and (easier to see in FIG. 4 showing section B of FIG. 2) a circumferential groove which accommodates a large underlay plate.

FIG. 5 shows a further washer formed from an elastomeric material the diameter of which approximately matches that of the integrated underlay plate 16 and the internal diameter of which is calculated such that it can be removed over the threaded section 15. When the bolt 11 is screwed up on the anchor point 3 on the fuselage 4 or the anchor point 5 of a wing surface, the washer 18 of FIG. 5 lies between the integrated washer 16 and the surface of the fuselage or the wing surface and thus protects them from any damage.

FIG. 6a shows a top view of the bolt 11 on top of an underlay plate 20 in the form of a circular sector which makes a 90° sector of a circle with a radius of approximately 200 mm. The sectional view through the axis of the bolt of FIG. 6b shows the underlay plate 20 disposed in a circumferential groove 18 on the head of the safety bolt 11 below the outer fixing ring 12 but still above the integrated washer 16 which, apart from the elastomeric washer 18 lying below it, comes into contact with the fuselage or the wing surface.

The surface area of the circular sector-shaped large surface area underlay plate is approximately 300 cm².

FIG. 7a shows another top view of a bolt on top of another large surface area underlay plate 21 which in this case is circular and has a diameter of approximately 200 mm. In the centre of this underlay plate 21 and around the head of the bolt 11 are a series of ray-like circular openings. The sectional view of FIG. 7b shows the underlay plate 21 in the same groove 17 of a threaded bolt 11 as in the case of the underlay plate of FIG. 6b with a circular sector shape.

Because of the arrangement of the groove 17, the remaining part of the head between this groove and the threaded section 15, in particular the integrated washer 16 and the elastomeric underlay plate 18, there remains a certain distance to the top surface of the wing surface or fuselage so that the large surface area underlay plates 20 and 21 are each at a distance from the fuselage or the wing surface; the circular underlay plate 21 is used on the anchor point 5 of the wing surface, while the circular sector shaped underlay plate 20 is used on the anchor point 3 of the fuselage 4 of the aircraft.

These large surface area underlay plates act in the first place to protect the surface of the wing surface and fuselage in the vicinity of the anchor points, for example when attaching the bolts, on hooking on a spring hook or when handling tools at the anchor point. Simultaneously, these underlay plates also act as a warning that the safety bolts might still be in the threaded sheaths at the anchor points even when, for example, the cable and any vacuum anchors have been removed from the wing surface.

The safety cable itself is preferably constructed so that it has a cable core which can accommodate tensile forces and a cable casing which protects the core of the cable against wear, soiling and radiation and also provides a soft and smooth surface with a good feel. The cable preferably has only elastic resilience and in particular in the pre-stressed condition has a maximum load-extension of 1.5% per kN, preferably approximately 1% per kN. Starting from the forementioned preferred values for the pre-tensing and the load threshold for the damping device, the force from pre-tensing (0.5 kN) can rise to a threshold of 4 kN tensile force in the cable, for example, so that as a result if the load-extension mentioned above is maintained, the cable stretches by a maximum of 4%, corresponding to a change in length of 1.2 m. If an additional vacuum anchor is provided which is arranged in the centre between the anchor points, the cable is only deflected between the vacuum anchor and one anchor point, and stretched over a distance of about 15 m. The length change in this section only will be transformed into a lateral deflection. This provides a maximum lateral deflection in the centre between the anchor and anchor point of 3.05 m for a deflection angle (with respect to the straight path of the cable) of approximately 22.2°. The peak load on a falling person would then be approximately 3 kN, corresponding to approximately 3 times fuselage weight if the person plus equipment weighed approximately 100 kg. Clearly, lighter people would be braked correspondingly earlier and the deflection would be smaller.

The breaking load of the cable used in the preferred embodiment of the invention should be over 6 kN, in particular over 8 or 10 kN.

Since on falling the cable is only a primary anchor of a PPE and on failing there is usually a deflection perpendicular to the cable path, in contrast to the usual safety lines it is not so important that the cable should have a high load-extension since the extension of the cable by means of the lateral deflection is approximately proportional to the reciprocal of the sine of the deflection angle corresponding to the fall distance. This geometry of the arrangement also substantially damps the peak loads on the falling person.

Preferred cables generally have a cable casing formed from parallel, essentially longitudinally aligned strands or fibres in contrast to twisted or braided cable cores which on loading can stretch considerably more.

The pre-tensing also ensures that the generally larger initial extension of such a cable is already compensated for when the rope is stretched between the anchor end points and is pre-tensed by the tensing device.

1. A device for securing persons on maintenance work on aircraft wing surfaces having a cable (2) stretched above the wing surface (1), characterized in that the cable (2) is stretched between a defined first anchor point (3) on the fuselage (4) above the wing surface (1) and a second defined anchor point (5) on the upper side of the wing surface (1) in the vicinity of the tip of the wing surface, wherein a damping device (7) is provided between said first and second anchor points (3, 5) whereby tensile forces arising in the cable result in a defined lengthening of the cable.

2. A device according to claim 1, characterized in that the damping device (7) effectively lengthens the cable by an amount which is dependent on the values of the tensile force which arise.

3. A device according to claim 1, characterized in that the damping device is designed such that on reaching an upper threshold of the tensile stress in the cable (2), which is a maximum of 6 kN, a limited additional amount of cable length is released.

4. A device according to claim 1, characterized in that the damping device is in the form of a safety line with a predetermined load-extension.

5. A device according to claim, characterized in that the cable has a load-extension between 0.5% and 2% per kN (kiloNewton).

6. A device according to claim 5, characterized in that the cable has a load-extension between 0.8% and 1.2% per kN.

7. A device according to claim 1, characterized in that the damping device (7) is designed such that it stops release of the cable as soon as the tensile stress in the cable (2) drops below a lower threshold.

8. A device according to claim 1, characterized in that between the anchor end points (3, 5) is a cable tensing device which produces a predetermined cable tension in the cable (2).

9. A device according to claim 8, characterized in that the cable tensing device is designed to adjust the cable tension to at least approximately 0.5 kN.

10. A device according to claim 1, characterized in that in an intermediate region between the anchor points (3, 5) there is provided an additional vacuum anchor (6) for attachment to the wing surface in order to protect the tensed cable (2) against local lateral deflections.

11. A device according to claim 1, characterized in that a ¾ inch thread is provided at the anchor points (3, 5) and in that the anchor end points each have a threaded bolt (11) which matches said thread and has a cable ring (12).

12. A device according to claim 1, characterized in that at least one guide bush (9) which grips the cable is provided to connect a safety line with the cable (2).

13. A device according to claim 12, characterized in that at least two guide bushes (9) are provided.

14. A device according to claim 12, as dependent on claim 10, characterized in that on each side of the vacuum anchor (6) at least one, preferably at least two guide bushes (9) are provided.

15. A device according to claim 12, characterized in that the at least one guide bush (9) has a safety clamp device which, upon sudden longitudinal displacement of the guide bushes (9) along the cable (2), clamps the guide bushes (9) on the cable (2).

16. A device according to claim 11, characterized in that large surface area underlay plates (20, 21) are provided beneath the threaded bolts, the colour of which is clearly distinct from the colour of the wing surface and the fuselage in the region of the anchor points.

17. A device according to claim 16, characterized in that the surface area of each of the underlay plates (20, 21) is at least 100 cm², preferably at least 200 cm².

18. A device according to claim 1, characterized in that the cable (2) in the pre-tensed state has a maximum load-extension of 2% per kN, preferably less than 1.5% per kN and in particular approximately 1% per kN.

19. A device according to claim 1, characterized in that the cable is designed to bear a dynamic load of at least 10 kN.

20. A device according to claim 1, characterized in that the cable consists of a cable core and a cable casing wherein the cable core is constructed from essentially parallel fibres or strands aligned longitudinally to the direction of the cable, while the cable casing is formed from a braided material, preferably polypropylene.

21. A device according to claim 20, characterized in that the cable has a diameter of 14 to 18 mm, preferably 16 mm.
